(19) United States
(12) Patent Application Publication
(10) Pub. No.: US 2014/0255124 A1
(43) Pub. Date: Sep. 11, 2014

(54) SHEET PROCESSING APPARATUS, BOOKLET BOOKBINDING METHOD, AND BOOKLET

(71) Applicant: CANON KABUSHIKI KAISHA, Tokyo (JP)

(72) Inventor: Rikiya Takemasa, Kashiwa-shi (JP)

(73) Assignee: CANON KABUSHIKI KAISHA, Tokyo (JP)

(21) Appl. No.: 14/192,081

(22) Filed: Feb. 27, 2014

(30) Foreign Application Priority Data
Mar. 6, 2013 (JP) 2013-044060

(51) Int. Cl. B42C 19/02; B42C 1/12; B42C 11/02

(52) U.S. Cl. CPC B42C 19/02; B42C 11/02; B42C 1/12
USPC 412/4; 412/16; 281/15.1

(57) ABSTRACT

A sheet processing apparatus scores a plurality of score lines at a plurality of positions of a cover sheet. The positions of the score lines corresponding to a plurality of side edges of a sheet bundle in covering the sheet bundle by the cover sheet. The sheet processing apparatus binds the sheet bundle with the cover sheet by binding first ends of the sheet bundle and the cover sheet.

### BACKGROUND OF THE INVENTION

1. Field of the Invention

The present invention relates to a sheet processing apparatus configured to process sheets, a booklet bookbinding method, and a booklet.

2. Description of the Related Art

Lately, an image forming apparatus such as a copier, a printer, and a facsimile is known to include a sheet processing apparatus performing such sheet processing as a stapling and a sorting to sheets on which images have been formed. However, such sheet processing apparatus has a drawback that stapler needles appear on a surface a stapled sheet bundle, thus degrading an outlook appearance of the finish bundle.

Then, in order to solve this problem, Japanese Patent Application Laid-open No. 2007-182072 for example proposes a sheet processing apparatus configured to cover a sheet bundle by a cover sheet which is folded-back along an external shape of the sheet bundle to hide stapler needles. There is also known an apparatus configured to bind a sheet bundle by such method as perfect binding of binding sheets by using adhesive, such as gluing bookbinding and tape bookbinding, in order to bind a good looking booklet. It has been normal to improve the appearance of the booklet by such methods in the past.

However, although the technology described in Japanese Patent Application Laid-open No. 2007-182072 enables to improve the appearance by hiding the stapler needles by enveloping the booklet by the cover sheet, it is inconvenient in terms of handling because the cover sheet is apt to be separated from a bookblock of the booklet just by enveloping by the cover sheet.

Still further, although it is possible to make the cover sheet harder to separate from the bookblock by binding as a booklet by means of the gluing bookbinding and tape bookbinding, there is a possibility of hampering an appearance of the booklet by irregularities caused on a surface of the sheet bundle by the binding adhesive. Furthermore, this case requires glue or a tape, possibly causing such problems that this case increases not only a manufacturing cost of the sheet bundle, but also a scale and complexity of the apparatus, and booklet cannot be readily prepared.

### SUMMARY OF THE INVENTION

According to a first aspect of the present invention, an sheet processing apparatus configured to process a sheet bundle and a cover sheet covering the sheet bundle, includes a scoring portion configured to score a plurality of score lines at a plurality of positions of the cover sheet, the positions of the score lines scored by the scoring portion corresponding to a plurality of side edges of the sheet bundle in covering the sheet bundle by the cover sheet, a sheet stacking portion configured to stack the sheet bundle and the cover sheet in a state in which first ends thereof are aligned, and a binding portion configured to bind the sheet bundle with the cover sheet respectively stacked on the sheet stacking portion by binding the first ends of the sheet bundle and the cover sheet.

According to a second aspect of the present invention, a booklet bookbinding method includes steps of conveying a plurality of sheets forming a bookblock of a booklet and a cover sheet having a size larger than each sheet of the bookblock and forming a cover of the booklet, scoring a plurality of score lines on the cover sheet at a plurality of positions corresponding to a plurality of side edges of the bookblock along a width direction orthogonal to a sheet conveying direction in covering the bookblock by the cover sheet, stacking the bookblock and the cover sheet scored by the scoring portion in a state in which first ends in the sheet conveying direction thereof are aligned, and binding the bookblock with the cover sheet stacked in the sheet stacking step by binding the first ends in the sheet conveying direction of the bookblock and the cover sheet to form a booklet in which a second end in the sheet conveying direction opposite from the first end of the cover sheet extends out of the bookblock.

According to a third aspect of the present invention, a booklet includes a plurality of sheets forming a bookblock and a cover sheet having a size larger than each sheet of the bookblock and forming a cover of the booklet, the bookblock being bound with the cover sheet by binding first ends of the bookblock and the cover sheet, the cover sheet having a plurality of score lines scored at positions corresponding to a plurality of side edges of the bookblock such that the cover sheet whose first end is aligned with the first end of the bookblock is folded back at a second end opposite from the first end and is turned around to a back of the bookblock so as to cover the first end of the bookblock.

Further features of the present invention will become apparent from the following description of exemplary embodiments (with reference to the attached drawings).

### BRIEF DESCRIPTION OF THE DRAWINGS

FIG. 1 is a schematic diagram showing an image forming apparatus including a sheet processing apparatus of an embodiment of the present invention.

FIG. 2 is a front view showing an overall structure of the sheet processing apparatus of the present embodiment.

FIG. 3A is a section view of a scoring device of the present embodiment viewed from a side of the apparatus.

FIG. 3B is a section view of the scoring device of the present embodiment viewed from a front side of the apparatus.

FIG. 4A is a schematic diagram showing a state in which a sheet has come to be conveyed to the scoring device of the present embodiment.

FIG. 4B is a schematic diagram showing a state in which a pressing member of the scoring device drops from the state shown in FIG. 4A.

FIG. 4C is a schematic diagram showing a state in which the pressing member of the scoring device is forming a score line on a sheet.

FIG. 4D is a schematic diagram showing a state in which the pressing member of the scoring device is lifted from the state shown in FIG. 4C.

FIG. 5 is a section view showing a side stitching portion of the present embodiment viewed from the front side of the apparatus.

FIG. 6 is a plan view showing the side stitching portion of the present embodiment.

FIG. 7A is a section view showing the side stitching portion of the present embodiment viewed from the front side of the apparatus.

FIG. 7B is a schematic diagram explaining moves of upper discharge rollers in aligning an upstream end of a sheet.

FIG. 8A is a schematic diagram showing the side stitching portion when the alignment of a first page sheet is finished.

FIG. 8B is a schematic diagram showing the side stitching portion when a second page sheet has come to be conveyed.

FIG. 9 is a section view showing an operation of the side stitching portion of the present embodiment viewed from the front side of the apparatus.

FIG. 10 is a block diagram showing a control system of the image forming apparatus including the sheet processing apparatus of the present embodiment.

FIG. 11 is a block diagram showing a control system of a sheet processing apparatus control portion of the sheet processing apparatus of the present embodiment.

FIG. 12 is a flowchart explaining an operation of the sheet processing apparatus of the present embodiment.

FIG. 13 is a perspective view of a sheet scored by the scoring device of the present embodiment.

FIG. 14 is a perspective view showing a state of bookbinding by using the sheet scored by the scoring device of the present embodiment.

FIG. 15 is a perspective view showing a sheet bundle forming a bookblock.

### DESCRIPTION OF THE EMBODIMENTS

An image forming apparatus of an embodiment of the present invention will be explained with reference to the drawings. The image forming apparatus 500 of the present embodiment is composed of a color printer including a sheet processing apparatus 100 having a function of a saddle stitch bookbinding device. It is noted that the image forming apparatus may be not only the color printer but also a monochrome printer, a facsimile, and a multifunction printer. A sheet processing method of the invention will be described in a description of each process of the sheet processing apparatus 100.

### [Image Forming Apparatus]

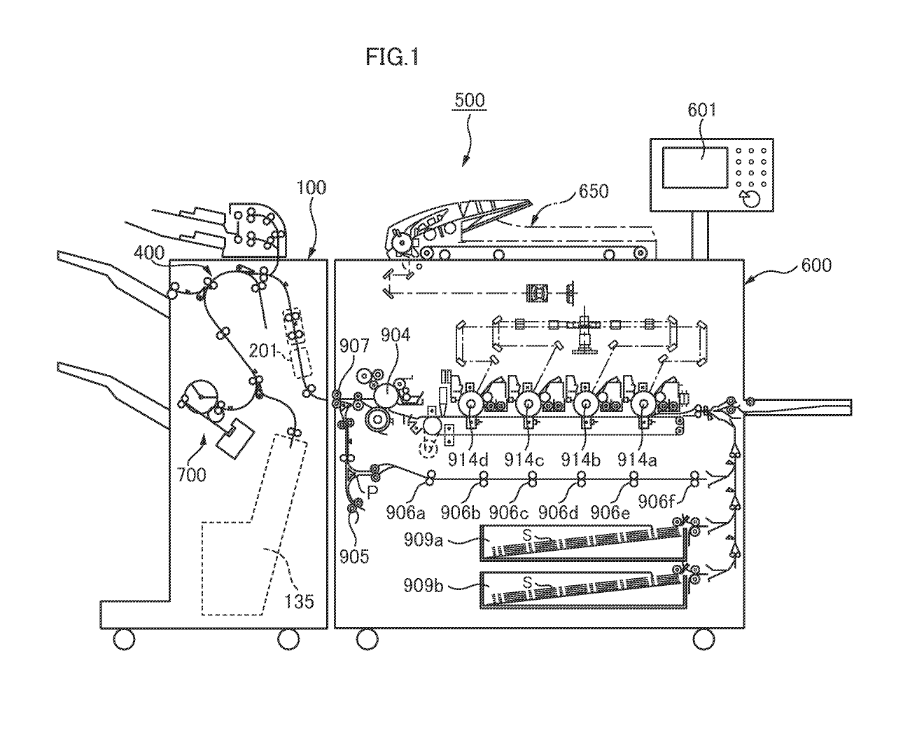

As shown in FIG. 1, the image forming apparatus 500 includes a body 600 of the image forming apparatus (referred to as an “apparatus body 600” hereinafter) capable of executing formation of monochrome and color images and the sheet processing apparatus 100 connected to the apparatus body 600. The image forming apparatus 500 is configured such that a sheet S discharged out of the apparatus body 600 can be processed in the sheet processing apparatus 100 connected online. The apparatus body 600 is provided with a document feeder 650 at an upper part thereof.

It is noted that the apparatus body 600 is configured such that it is usable in a state in which the sheet processing apparatus 100 is not connected to a discharge port thereof. The sheet processing apparatus 100 may be also incorporated integrally in the apparatus body 600.

The apparatus body 600 is provided with a manipulation portion 601 for making various inputs and settings disposed at one upper end (on aright side in FIG. 1) thereof. Here, a position where a user faces the manipulation portion 601 to make various inputs and settings to the apparatus body 600 will be defined as a “front side” of the image forming apparatus 500 and a back side of the image forming apparatus 500 will be defined as a “rear side” hereinafter. FIG. 1 shows a configuration of the image forming apparatus 500 viewed from the front side. The sheet processing apparatus 100 is connected to one side (the left side in FIG. 1) of the apparatus body 600.

In the apparatus body 600, four colors of toner images are transferred to the sheet S fed from a sheet cassette 909a or 909b by photoconductive drums 914a, 914b, 914c and 914d and others corresponding to yellow, magenta, cyan and black toners. The photoconductive drums 914 through 914d and others compose an image forming portion forming an image on the sheet S. The sheet processing apparatus 100 processes the sheet S on which an image has been formed by the image forming portion.

The sheet S on which the toner images have been transferred is conveyed to a fixing unit 904 disposed downstream of the image forming portion to fix the toner images. In a case of a mode of forming an image on one side of the sheet, the sheet S is discharged out of the apparatus body 600 by a discharge roller pair 907 as it is.

Meanwhile, in a case where a double face image forming mode is selected, the sheet S is passed from the fixing unit 904 to a reversing roller pair 905. The reversing roller pair 905 rotates in reverse at a point of time when a rear edge in a sheet conveying direction of the sheet S crosses a reverse switching portion P. Thereby, the sheet S is conveyed in a direction of double face conveying roller pairs 906a, 906b, 906c, 906d, 906e, and 906f opposite from the sheet conveying direction.

Then, four colors of toner images are transferred again to the back face of the sheet S by yellow, magenta, cyan and black photoconductive drums 914a, 914b, 914c and 914d and others. The sheet S to which the toner images have been transferred on the both faces thereof is conveyed again to the fixing unit 904 to fix the toner images and is discharged out of the apparatus body 600 through the discharge roller pair 907.

### [Configuration of Sheet Processing Apparatus]

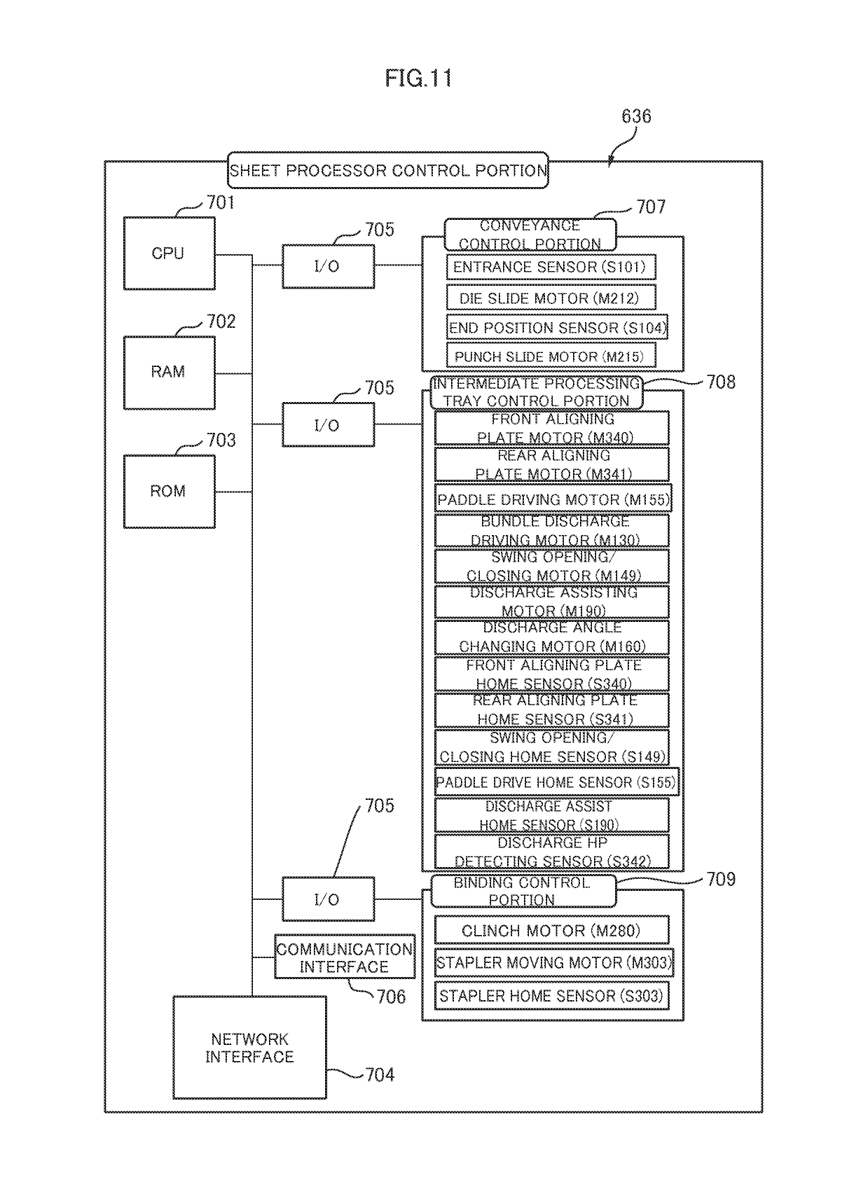

As shown in FIG. 1, the sheet processing apparatus 100 includes a scoring device 201, a conveyance processing portion 400, a side stitching portion 700, and a saddle stitching portion 135, respectively controlled by the sheet processing apparatus control portion 636 (see FIG. 11).

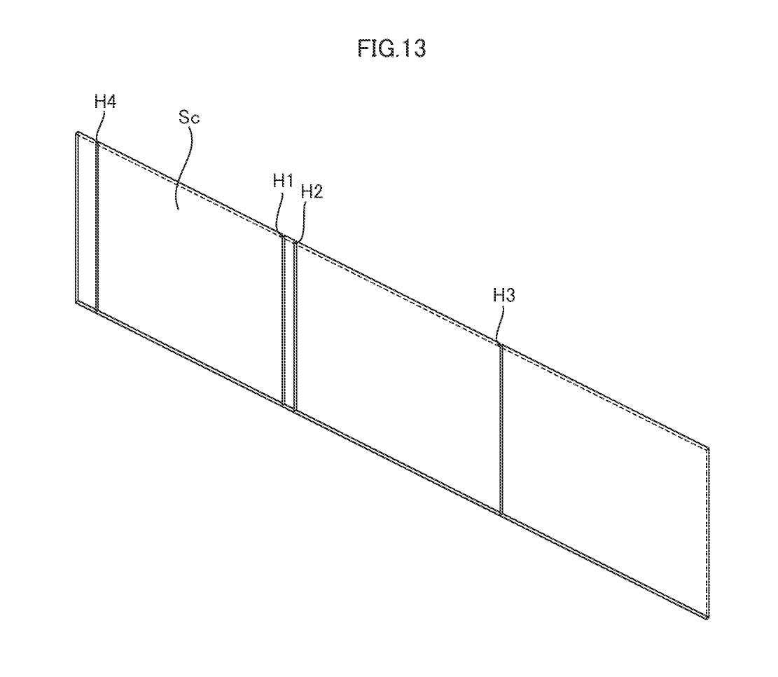

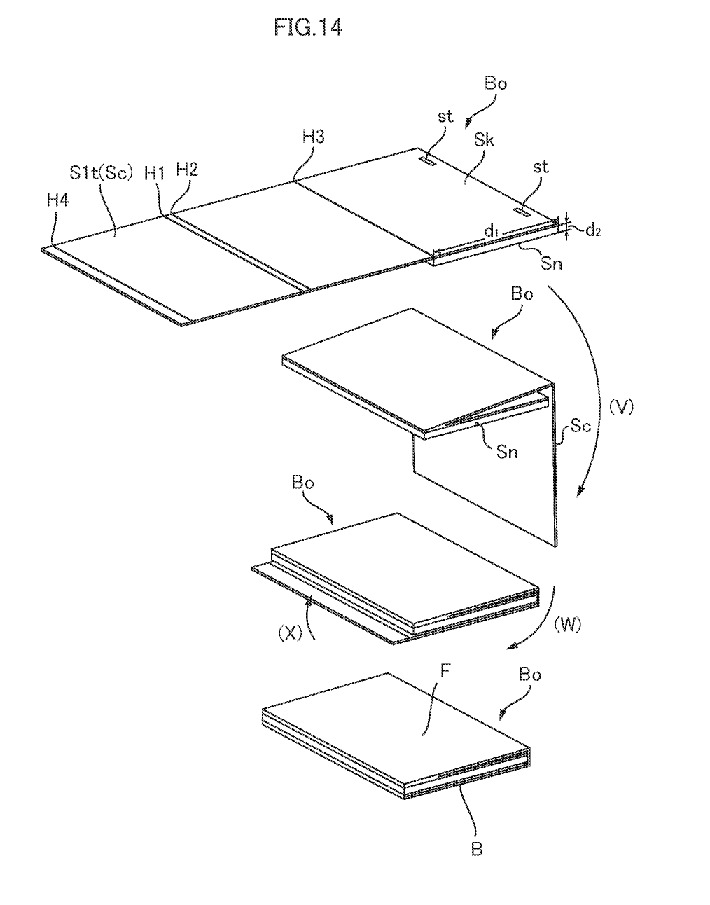

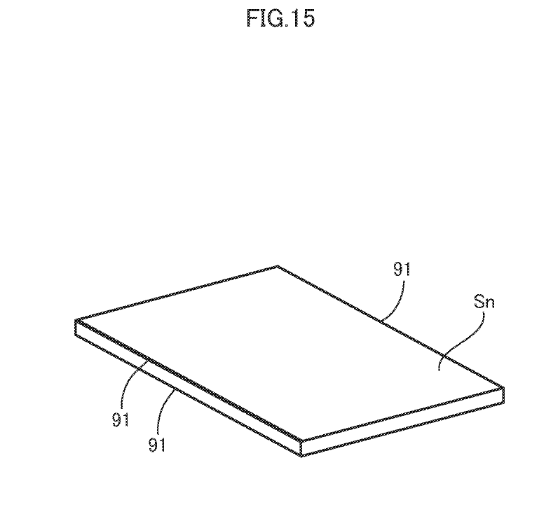

The scoring device 201 composes a scoring portion. The scoring device 201 scores a plurality of score lines H1 through H4 on a cover sheet Sc (see FIGS. 13 through 15) along a width direction orthogonal to the sheet conveying direction while leaving spaces in the sheet conveying direction such that the score lines coincide with a plurality of side edges of a bookblock sheet bundle Sn (referred to simply as a “bookblock” hereinafter) to cover the bookblock Sn (see FIGS. 14 and 15). It is noted that FIG. 15 is a perspective view showing the bookblock Sn having the plurality of side edges 91.

That is, the scoring device 201 scores the plurality of score lines H1 through H4 on the cover sheet Sc such that the score lines coincide with the plurality of side edges 91 of the bookblock Sn (see FIG. 15) such that the cover sheet Sc whose upstream end (first end) in the sheet conveying direction is aligned with that of the bookblock Sn is folded back at a downstream end (second end) of the bookblock Sn and is turned to a back of the bookblock Sn so as to cover the upstream end of the bookblock Sn. Such a scoring process is carried out by the scoring portion.

The side stitching portion 700 composes a sheet stacking portion configured to stack the bookblock Sn and the cover sheet Sc scored by the scoring device 201 in a state in which their upstream ends in the sheet conveying direction are aligned. The sheet stacking portion carries out a sheet stacking process.

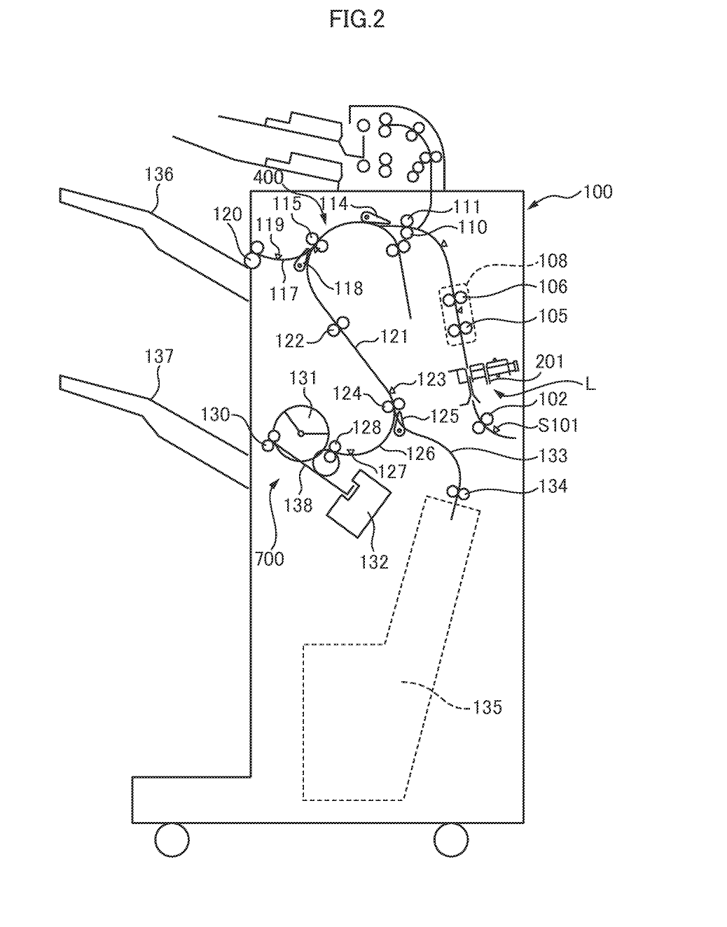

As shown in FIG. 2, the sheet processing apparatus 100 is provided with an entrance sensor S101 detecting a conveyed sheet S near an inlet port of sheets conveyed from the apparatus body 600. An inlet roller pair S102 is disposed downstream of the entrance sensor S101, and the scoring device 201 and a shift unit 108 having shift roller pairs 105 and 106 are disposed sequentially downstream of the entrance roller pair 102.

The roller pairs 102, 105 and 106 compose a sheet conveying portion conveying a plurality of sheets forming the bookblock Sn of the booklet Bo (see FIG. 14) and the cover sheet Sc having a size larger than each sheet of the bookblock and forming the cover sheet of the booklet Bo. This sheet conveying portion carries out a sheet conveying process. It is noted that a plurality of bookblock sheets S composes the bookblock Sn.

The booklet Bo is fabricated by binding the plurality of bookblock sheets forming the bookblock Sn and the cover sheet Sc having the size larger than each sheet of the bookblock and forming the cover sheet of the booklet Bo by binding one ends of the bookblock and the cover sheet. The score lines H1 through H4 are provided on the cover sheet Sc such that they coincide with the plurality of side edges of the bookblock (see FIG. 14). These score lines are provided to fold back the cover sheet Sc, whose upstream end in the sheet conveying direction is aligned with that of the bookblock Sn, at the downstream end in the sheet conveying direction of the bookblock and to turn to a back side of the bookblock so as to cover the upstream end in the sheet conveying direction of the bookblock. The score lines H1 through H4 of the cover sheet Sc are a score line H1 (third score line), a score line H2 (second score line), a score line H3 (first score line), and a score line H4 (fourth score line) as described later (see FIG. 14).

As shown in FIG. 2, the conveyance processing portion 400 includes a conveying roller 110 and a separation roller 111 disposed downstream of the shift unit 108, a change-over member 114 configured to change over conveying paths, and a conveying roller pair 115. The conveyance processing portion 400 also includes a change-over member 118 configured to change over conveying paths, an upper pass conveying path 117, a sheet detection sensor 119 detecting a sheet conveyed on the upper conveying path 117, an upper discharge roller pair 120 discharging the sheet S to an upper discharge tray 136. The conveyance processing portion 400 also includes a bundle conveying path 121 and a third buffer roller pair 122 disposed along the bundle conveying path 121.

As shown in FIG. 2, the side stitching portion 700 includes a sheet detection sensor 123 detecting a sheet, a bundle conveying roller pair 124 conveying the sheet, and a member 125 changing over sheet conveying paths. The side stitching portion 700 also includes a conveying path 126, a sheet detection sensor 127 detecting a sheet conveyed through the conveying path 126, a stapler 132, a processing tray 138 and drawing paddles 131 as a return portion.

The stapler 132 composes a binding portion. The binding portion binds the bookblock Sn with the cover sheet Sc stacked on the processing tray 138 of the side stitching portion 700 in a state in which the upstream ends in the sheet conveying direction thereof are aligned to form the booklet Bo in which the downstream end in the sheet conveying direction of the cover sheet Sc extends out of the bookblock Sn. The binding portion carries out a binding process.

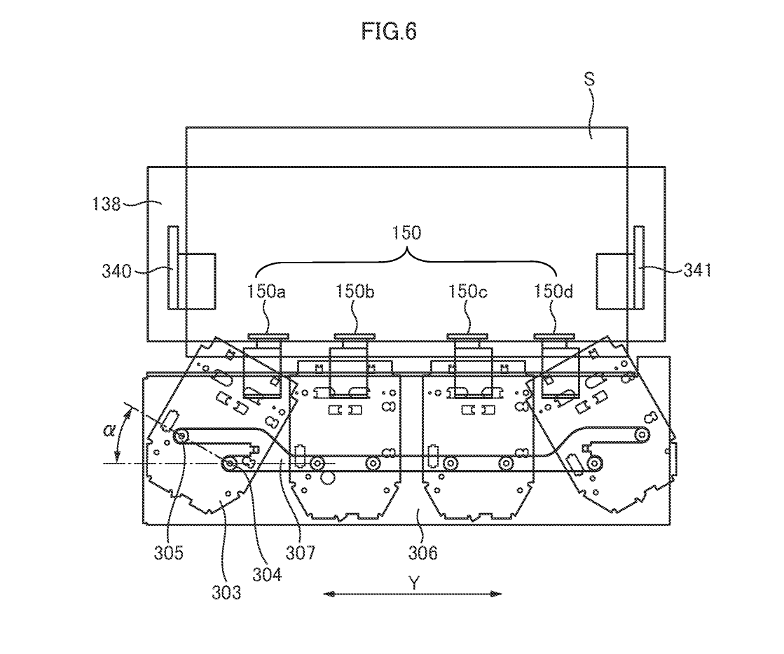

As a sheet discharge portion, the side stitching portion 700 also includes a lower discharge roller pair 128 and a discharge roller pair 130 discharging a sheet to a lower discharge tray 137. Front and rear side aligning plates 340 and 341 (see FIG. 6) are disposed on the processing tray 138 while leaving a space from each other. The side stitching portion 700 performs a side stitching process selectively to sheets sent from the apparatus body 600.

### [Outline of Operations of the Sheet Processing Apparatus 100]

As shown in FIG. 2, the sheet S discharged out of the apparatus body 600 is passed to the entrance roller pair 102 in the sheet processing apparatus 100. At this time, the entrance sensor S101 also detects a passing timing of the sheet S in the same time. An edge detection sensor S104 (see FIG. 11) detects a position of a widthwise edge orthogonal to the sheet conveying direction of the sheet S conveyed by the entrance roller pair 102. On a basis of the detection result of the edge detection sensor S104, the sheet processing apparatus control portion 636 (see FIG. 11) detects a degree of a widthwise error of the widthwise position of the conveyed sheet shifting from a widthwise conveying center position.

After the detection of the widthwise error of the sheet, a shift unit 108 implements a shift operation of moving the sheet to the front and rear sides in the width direction by a predetermined amount into which the error during when the sheet is conveyed by shift roller pairs 105 and 106. After that, the sheet is conveyed by the conveying roller 110 and the separation roller 111 as well as a conveying roller pair 115.

After that, in a case where the sheet is to be discharged to the upper discharge tray 136, the sheet is guided to an upper conveying path 117 by a change-over member 118 which is changed over by a drive portion such as a solenoid not shown and is discharged to the upper discharge tray 136 by an upper discharge roller pair 120.

Meanwhile, in a case where the sheet is not discharged to the upper discharge tray 136, the sheet is guided to the bundle conveying path 121 by the change-over member 118 which changes over the path while being conveyed by the conveying roller pair 115. Then, the path of the sheet is changed over by the change-over member 125, and the sheet is guided to the side stitching portion 700 or the saddle stitching portion 135 while being conveyed by the bundle conveying roller pair 124.

That is, in a case where a saddle stitching process of stitching a center part of the sheet in the width direction orthogonal to the sheet conveying direction is to be carried out, the change-over member 125 is changed over by a solenoid or the like not shown and the sheet conveyed by the bundle conveying roller pair 124 is conveyed to a saddle stitching path 133. Then, the sheet is guided to the saddle stitching portion 135 by a saddle inlet roller pair 134 to undergo the saddle stitching process.

In a case where the sheet is to be discharged to the lower discharge tray 137, the sheet whose path is changed over by the change-over member 125 and is conveyed by the bundle conveying roller pair 124 is guided to a conveying path 126, and is then discharged on the processing tray 138 by the lower discharge roller pair 128. After undergoing the side stitching process on the processing tray 138, the sheet is discharged to the lower discharge tray 137 by a discharge roller pair 130.

### [Detail of the Scoring Device 201]

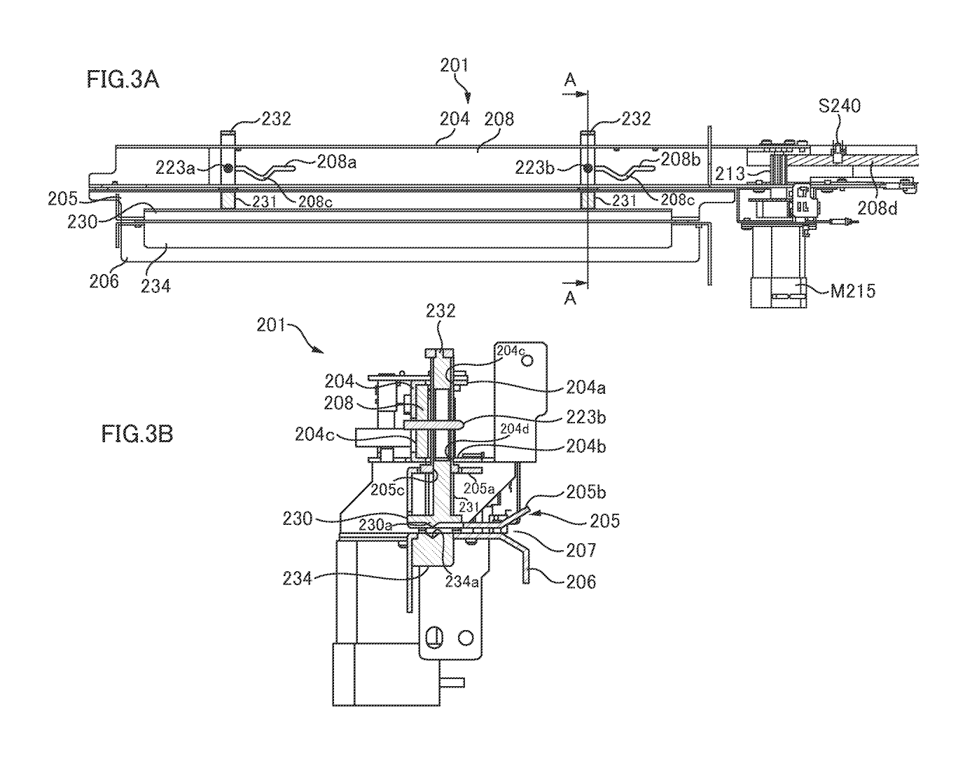

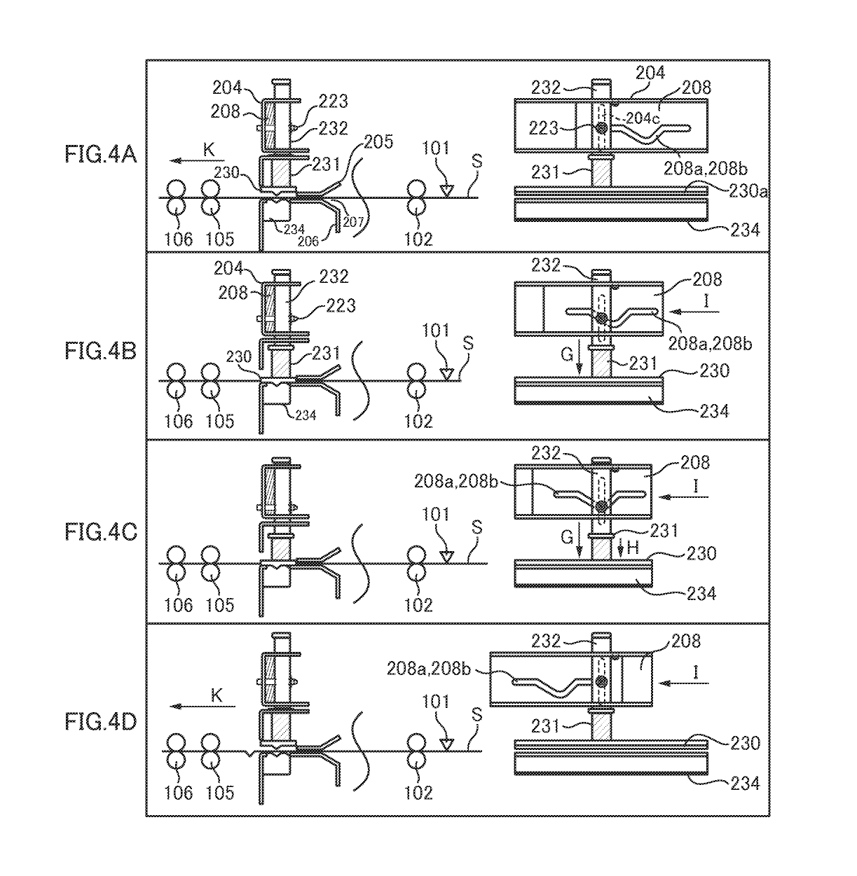

Next, a detail of the scoring device 201 will be described with reference to FIGS. 3A and 3B and FIGS. 4A through 4D. It is noted that FIG. 3A is a section view showing the scoring device 201 viewed from a direction of an arrow L in FIG. 2, i.e., from the side of the apparatus, and FIG. 3B is a section view showing the scoring device 201 viewed in section along a line A-A in FIG. 3A, i.e., from the front side of the apparatus.

As shown in FIGS. 3A and 3B, the scoring device 201 includes a first punch support guide 205 extending in a front and rear direction in FIG. 2, a second punch support guide 204, and a die support guide 206. The die support guide 206 is fixed to a body of the sheet processing apparatus 100.

The first punch support guide 205 extends in parallel with the die support guide 206 and is fixed to the die support guide 206 while forming a sheet conveying path 207 by leaving a predetermined gap between the first punch support guide 205 and the die support guide 206. The second punch support guide 204 extending in parallel with the first punch support guide 205 is fixed at an upper part of the first punch support guide 205.

The first punch support guide 205 is provided with slide support portions 205a and 205b bent so as to project from a vertical part thereof in a right direction in FIG. 3B. The second punch support guide 204 is also provided with slide support portions 204a and 204b bent so as to project from a vertical part thereof in the right direction in FIG. 3B.

A die 234 is fixed on the die support guide 206 so as to extend in parallel along the die support guide 206. The die 234 has a straight concave portion 234a extending along a longitudinal direction thereof while facing a pressing convex portion 230a of a pressing member 230 and receiving the pressing convex portion 230a. That is, the die 234 has the straight concave portion 234a extending in the width direction orthogonal to the sheet conveying direction. The pressing member 230 has the straight pressing convex portion 230a extending in parallel with the die 234 above the die 234 and entering the concave portion 234a, and is supported contactably/separably to/from the die 234.

The straight pressing member (punch) 230 extending in parallel with the die 234 is supported movably in the vertical direction by the first and second punch support guides 205 and 204. The pressing member 230 is provided with a pair of sliders 232 extending upward from positions near longitudinal both ends of the pressing member 230. The pressing member 230 is provided with the pressing convex portion 230a formed so as to extend along the longitudinal direction thereof and contactable/separable to/from the concave portion 234a of the die 234 as described above.

The slide support portion 205a of the first punch support guide 205 is provided with a slide hole 205c formed so as to support the slider 232 slidably such that the slider 232 penetrates through the slide hole 205c in the vertical direction. The slide support portions 204a and 204b of the second punch support guide 204 are provided with a slide hole 204d formed such that a position thereof is matched above the slide support portion 205a and the slide hole 204d slidably supports the slider 232 together with the slide hole 205c such that the slider 232 penetrates through the slide hole 204d in the vertical direction. Parallel pins (followers) 223a and 223b are driven respectively to the pair of sliders 232 slidably supported in the vertical direction by the slide support portions 204a, 204b and 205a.

A lengthy slide plate 208 extending in the longitudinal direction of the second punch support guide 204 is inserted slidably between the slide support portions 204a and 204b of the second punch support guide 204. The slide plate 208 has cam-like guide long holes 208a and 208b at positions respectively corresponding to the sliders 232. The parallel pins 223a and 223b driven respectively to the pair of sliders 232 penetrate through the cam-like guide long holes 208a and 208b.

A pair of guide long holes 204c straightly extending in the vertical direction while respectively facing the cam-like guide long holes 208a and 208b is formed at regions of the second punch support guide 204 facing the slide plate 208. The parallel pins 223a and 223b penetrating through the cam-like guide long holes 208a and 208b of the slide plate 208 penetrate respectively through the pair of guide long holes 204c.

The cam-like guide long holes 208a and 208b have profiles of guiding the parallel pins 223a and 223b in the vertical direction in cooperation with the pair of guide long holes 204c and of moving the pressing member 230 in the vertical direction through the sliders 232 when the slide plate 208 is moved. Pressing springs 231, i.e., compression springs, are compressively provided between an upper surface of the pressing member 230 and the slide support portion 205a to bias the pressing member 230 downward. During a normal time when the parallel pins 223a and 223b are located not at center curved parts 208c and 208d but at right and left flat parts of the cam-like guide long holes 208a and 208b, the pressing members 230 are not projected to the sheet conveying path 207.

A punch HP (home position) sensor S240 is disposed at a right end part of the second punch support guide 204 shown in FIG. 3A. The punch HP sensor S240 detects a home position of the pressing member 230 by detecting a move position of the slide plate 208.

A rack 208d is attached at a position facing the punch HP sensor S240 of the slide plate 208 along a direction in which the slide plate 208 extends. A punch slide motor M215 is attached at a position near the rack 208d in the second punch support guide 204. A pinion 213 is attached to a rotary shaft projecting above the punch slide motor M215, and a rotation of the punch slide motor M215, when it is driven, is transmitted to the slide plate 208 by engaging the pinion 213 with the rack 208d.

### [Detail of the Side Stitching Portion 700]

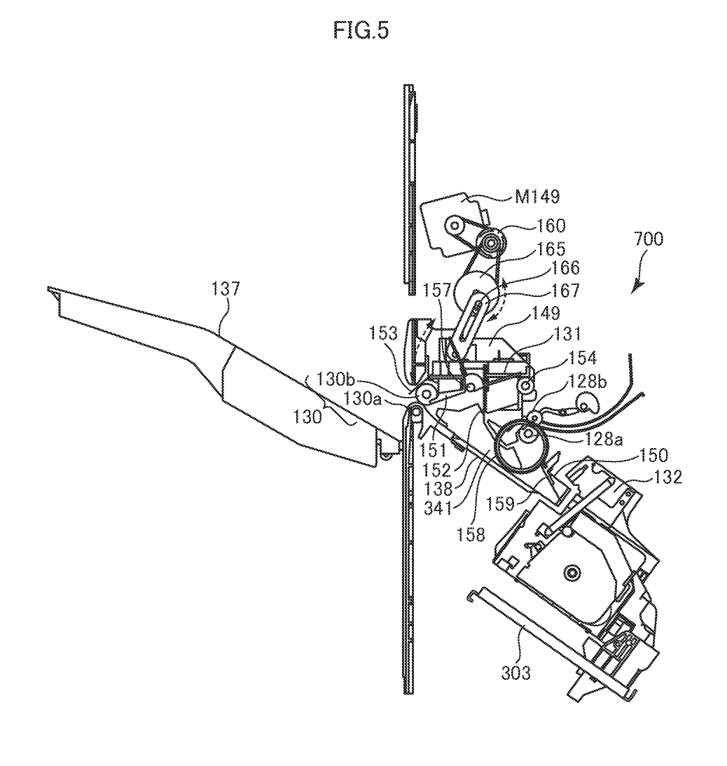

Next, a detail of the side stitching portion (processing tray portion) 700 will be explained. It is noted that FIG. 5 is a section view of the side stitching portion 700 viewed from the front side of the apparatus, and FIG. 6 is a plan view showing the side stitching portion 700.

As shown in FIG. 5, the processing tray 138 is disposed such that a downstream side (left side in FIG. 5) thereof is inclined upward and an upstream side (right side in FIG. 5) downward with respect to the sheet conveying direction of a sheet bundle. A rear end stopper (restricting member) 150 is disposed at an upstream end in the sheet conveying direction of the processing tray 138, and a lower discharge roller 130a of the discharge roller pair 130 is disposed at a downstream end in the sheet conveying direction of the processing tray 138.

A guide 151 and first and second discharging needles 152 and 153 are disposed respectively across a whole range in an axial direction in a swing guide 149. The swing guide 149 is supported turnably through a support shaft 154 and is swung in the vertical direction when a swing opening/closing motor M149 is driven.

An upper discharge roller 130b of the discharge roller pair 130 is disposed at an opening end of the openable swing guide 149. This upper discharge roller 130b approaches/separates to/from the lower discharge roller 130a along with the opening/closing operation of the swing guide 149.

The discharge roller pair 130 is configured to rotate normally and reversely as a rotational drive from a bundle discharge driving motor M130 (see FIG. 11), i.e., a driving portion, is applied to upper and lower discharge roller shaft thereof. Thus, the discharge roller pair 130 is configured to be able to convey the sheet S in a sheet discharge direction of discharging the sheet S to the lower discharge tray 137 and in the sheet conveying direction of conveying the sheet S to the processing tray 138 oppositely from the sheet discharge direction.

Next, the sheet rear end aligning portion will be explained. That is, as shown in FIG. 5, a belt roller 158, i.e., a sheet conveying portion, and a rear edge lever 159, i.e., a sheet pressing member, are disposed on the upstream side in the sheet conveying direction of the processing tray 138. While being guided by the rear edge lever 159, the sheet S abuts against the rear edge stopper 150 as the lower discharge roller pair 128, i.e., a sheet discharge portion, rotates in a direction of moving the sheet opposite from the sheet discharge direction and is aligned in the sheet conveying direction. The lower discharge roller pair 128 is composed of the discharge rollers 128a and 128b disposed so as to face with each other.

The belt roller 158 is wrapped around the discharge roller 128a of the lower discharge roller pair 128 and is driven by the rotation of the discharge roller 128a. The belt roller 158 is disposed above the processing tray 138 with such a positional relationship that a lower part of the belt comes in contact with an uppermost sheet stacked on the processing tray 138. The stapler 132 is fixed on a slide abutment 303.

Still further, as shown in FIG. 6, rollers 304 and 305 are disposed under the slide abutment 303. The slide abutment 303 moves in a direction of an arrow Y in FIG. 6 along a rear end edge (lower side in FIG. 6) of the sheet S stacked on the processing tray 138 by being guided by the rollers 304 and 305 and a guide rail groove 307 formed on a stapler moving stage 306.

As shown in FIG. 5, a plurality of drawing paddles 131 is fixed on a rotary shaft 157 along an axial direction of the rotary shaft 157 disposed above the processing tray 138 and linked and driven by a paddle driving motor M155 (see FIG. 11) through a gear train. The drawing paddles 131 are rotated counterclockwise at a fulcrum of the rotary shaft 157 by the paddle driving motor M155 at an adequate timing.

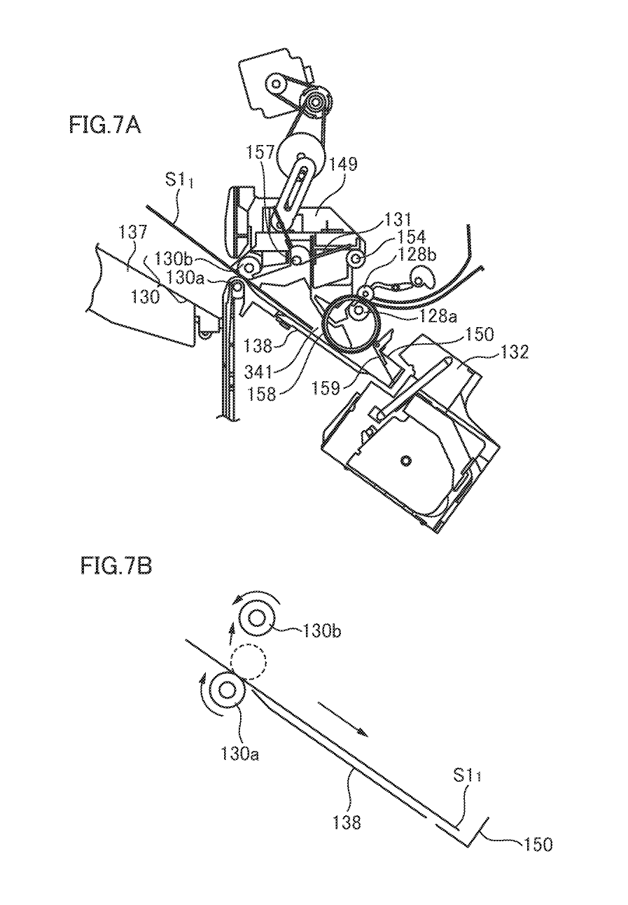

The provision of the plurality of drawing paddles 131 as described above permits to make the plurality of drawing paddles 131 contact homogeneously with a surface of the sheet in drawing the sheet S into the rear edge stopper 150 and to prevent the sheet S otherwise from turning due to inhomogeneous contact. Accordingly, it is possible to butt the sheet S reliably against the rear edge stopper 150 (150a, 150b, 150c, and 150d) without conveying the sheet S askew as shown in FIGS. 7A and 7B.

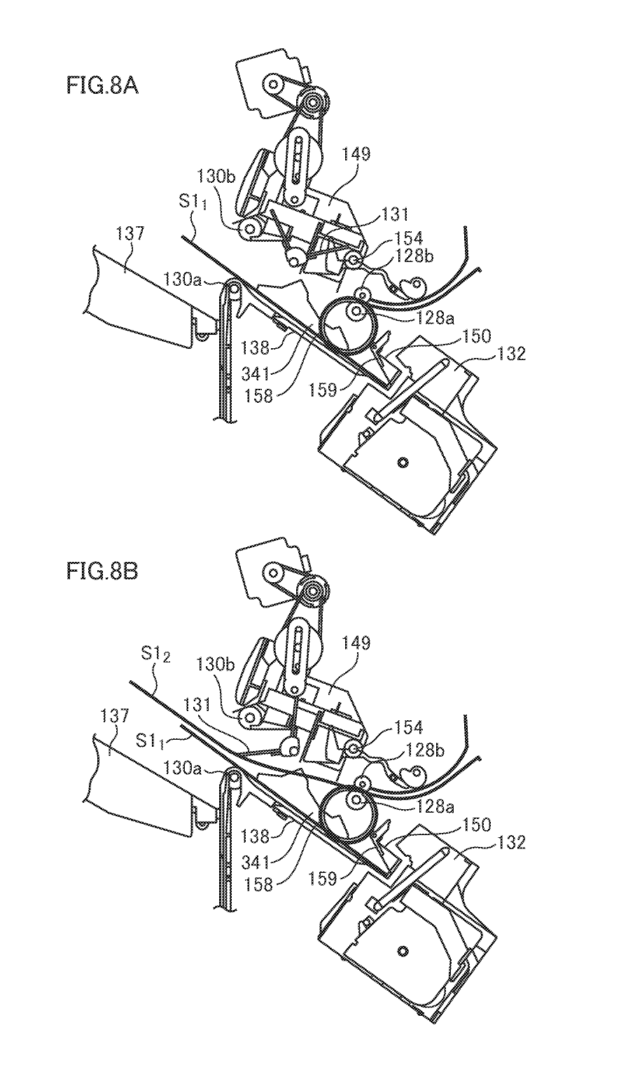

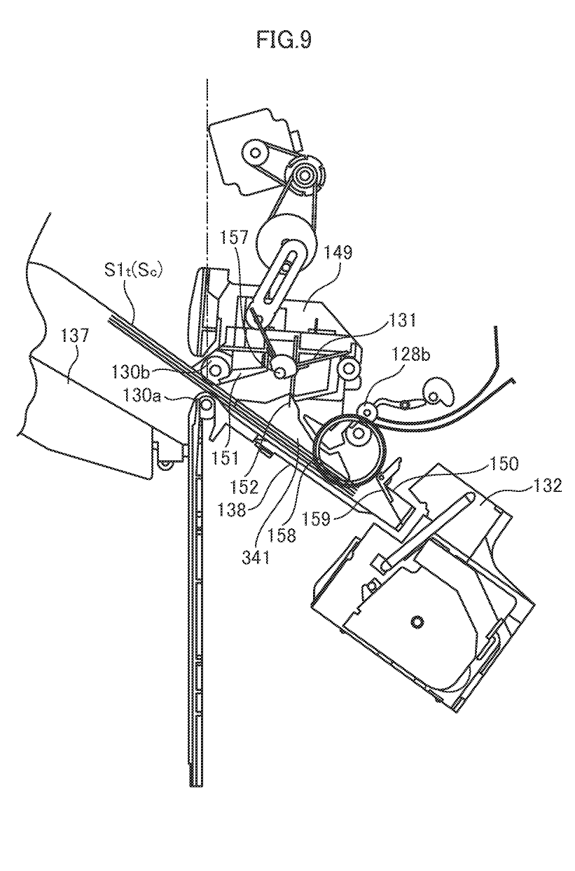

Next, an operation carried out in stapling a sheet bundle conducted when a stapling mode is selected will be explained with reference to FIGS. 7 through 9. It is noted that FIGS. 7A and 7B are section views showing the operations of the side stitching portion 700 viewed from the front side of the apparatus, FIGS. 8A and 8B are section views showing the operation of the side stitching portion 700 viewed from the front side of the apparatus, and FIG. 9 is a section view showing the operation of the side stitching portion 700 viewed from the front side of the apparatus.

That is, when the stapling mode is selected through the manipulation portion 601, the sheet S1₁ sent from the apparatus body 600 to the sheet processing apparatus 100 and passing through the scoring device 201 and the conveyance processing portion 400 is conveyed from the lower discharge roller pair 128 to the discharge roller pair 130 (see FIG. 7A).

Then, as the discharge roller pair 130 rotates reversely, the sheet S1₁ is conveyed in the direction opposite from the sheet discharge direction of the discharge roller pair 130 and the rear edge thereof abuts against the rear edge stopper 150. At this time, before when the rear edge of the sheet S1₁ abuts against the rear edge stopper 150, the swing guide 149 rises and the upper discharge roller 130b is separated from the lower discharge roller 130a (see FIG. 7B). Due to that, the sheet S1₁ is butted against and aligned by the rear edge stopper 150 by its inertia.

When the alignment of the upstream end (rear edge) in the sheet conveying direction of the sheet S1₁ is finished, an alignment in the width direction orthogonal to the sheet conveying direction is carried out continuously by the front and rear alignment plates 340 and 341 (see FIG. 8A).

Next, a sheet S1₂ of a second page of a first part (bundle) is discharged from the lower discharge roller pair 128 onto the processing tray 138. At this time, because the swing guide 149 is located at the rise position, the sheet S1₂ is received in the state in which the upper discharge roller 130b is separated from the lower discharge roller 130a. Then, when a rear edge of the sheet S1₂ passes through a nip portion of the lower discharge roller pair 128, the sheet S1₂ is discharged on the processing tray 138.

The end of the sheet S1₂ discharged onto the processing tray 138 is conveyed toward the rear edge stopper 150 as the drawing paddles 131 rotate in the direction of moving the sheet in the direction opposite from the sheet discharge direction of the lower discharge roller pair 128 (see FIG. 8B).

The sheet S1₂ is drawn further toward the rear edge stopper 150 by the belt roller 158 that rotates in the direction of moving the sheet in the direction opposite from the sheet discharge direction, and abuts against and is aligned by an abutting face of the rear edge stopper 150.

When the alignment of the upstream end (rear edge) in the sheet conveying direction of the sheet S1₂ is finished, the sheet S1₂ is aligned in the width direction by the front and rear aligning plates 340 and 341 similarly to the sheet S1₁. This series of operations is repeated until when a final sheet S1t (cover sheet Sc) of the first part is conveyed to the processing tray 138 and abuts against the rear edge stopper 150 (FIG. 9).

This final sheet Sit which has been conveyed to the scoring device 201 and has undergone the scoring process shown in FIGS. 4A through 4D is conveyed to the processing tray 138 to be aligned. When the alignment operation of the final sheet Sit is finished, a rear end edge of the sheet bundle is stapled by the stapler 132. Continuously, the swing guide 149 drops to nip the sheet bundle by the discharge roller pair 130 and to discharge to the lower discharge tray 137 (see FIG. 9).

### [Control System of the Image Forming Apparatus 500]

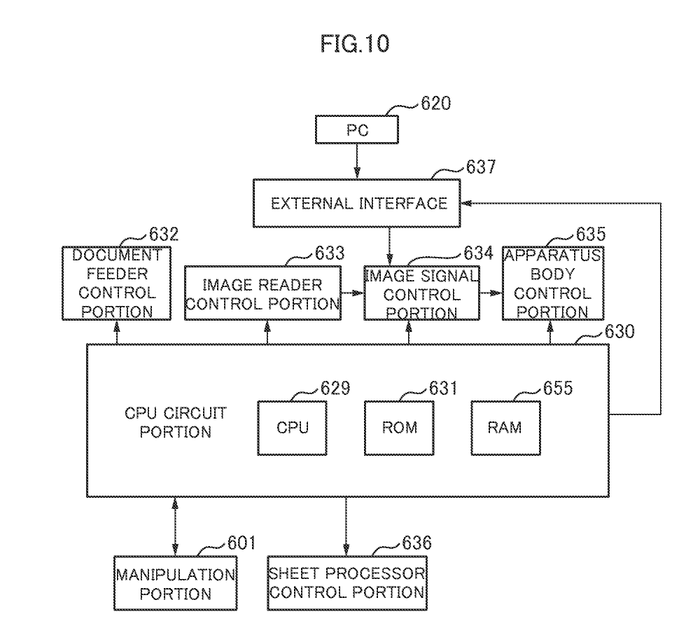

Next, a control system of the image forming apparatus 500 will be described. As shown in FIG. 10, the control system of the image forming apparatus 500 includes a CPU circuit portion 630 having a CPU 629, a ROM 631, and a RAM 655. The CPU circuit portion 630 is connected with a document feeder control portion 632, an image reader control portion 633, an image signal control portion 634, an apparatus body control portion 635, and a sheet processing apparatus control portion 636. The CPU circuit portion 630 is connected with a personal computer (PC) 620 through an external interface 637 and with the manipulation portion 601.

The CPU circuit portion 630 controls the document feeder control portion 632, the image reader control portion 633, the image signal control portion 634, the apparatus body control portion 635, and the sheet processing apparatus control portion 636 in accordance to programs stored in the ROM 631 and to setting made through the manipulation portion 601.

The document feeder control portion 632 controls operations of the document feeder 650 (see FIG. 1). The image reader control portion 633 controls operations of the image reader provided in the apparatus body 600. The apparatus body control portion 635 controls operations of the apparatus body 600. The sheet processing apparatus control portion 636 controls operations of the sheet processing apparatus 100.

The RAM 655 is used as an area for temporally holding control data and a working area of computation involved in the controls. The external interface 637 is an interface from the personal computer 620 and develops print data into an image and outputs to the image signal control portion 634.

An image read by an image sensor is outputted from the image reader control portion 633 to the image signal control portion 634, and the image outputted out of the image signal control portion 634 to the apparatus body control portion 635 is inputted to an exposure control portion not shown.

The sheet processing apparatus control portion 636 is mounted in the sheet processing apparatus 100 and controls drives of the whole sheet processing apparatus 100 by exchanging information with the CPU circuit portion 630 of the image forming apparatus 500. The sheet processing apparatus control portion 636 controls various motors and sensors described later and mounted in the sheet processing apparatus 100.

It is noted that while the sheet processing apparatus control portion 636 will be explained in terms of a configuration thereof mounted in the sheet processing apparatus 100 in the present embodiment, it is also possible to mount the sheet processing apparatus control portion 636 in the apparatus body 600 integrally with the CPU circuit portion 630. In such a case, the sheet processing apparatus 100 is controlled from the apparatus body 600.

### [Control System of the Sheet Processing Apparatus Control Portion]

Next, a control system of the sheet processing apparatus control portion 636 will be explained. As shown in FIG. 11, the sheet processing apparatus control portion 636 described above includes a microcomputer (CPU) 701, a RAM 702, a ROM 703, a communication interface 706, and a network interface 704. The sheet processing apparatus control portion 636 also includes an input/output portion (I/O) 705, a conveyance control portion 707, an intermediate processing tray control portion 708, and a binding control portion 709.

The CPU 701, the RAM 702, and the ROM 703 are connected to the network interface 704 and are also connected respectively to the conveyance control portion 707, the intermediate processing tray control portion 708, and the binding control portion 709 through the input/output portion (I/O) 705. The communication interface 706 is connected to the network interface 704. Various sensor signals are inputted to input ports of the input/output portion (I/O) 705 and respective driving systems are connected to output ports of the input/output portion (I/O) 705 connected through various drivers.

The conveyance control portion 707 includes the entrance sensor S101, the die slide motor M212, an end position sensor (end detection sensor) S104, and the punch slide motor M215. The conveyance control portion 707 executes control processes of scoring, detection of sheet horizontal registration detection, and others.

The intermediate processing tray control portion 708 includes a front aligning plate motor M340, a rear aligning plate motor M341, a paddle driving motor M155, a bundle discharge driving motor M130, a swing opening/closing motor M149, a discharge assist motor M190, and a discharge angle changing motor M160. The intermediate processing tray control portion 708 further includes a front aligning plate home sensor S340, a rear aligning plate home sensor S341, a swing opening/closing home sensor S149, a paddle drive home sensor S155, a discharge assist home sensor S190, and a discharge HP detection sensor S342.

The intermediate processing tray control portion 708 controls the operation of the front and rear aligning plates 340 and 341, the operation of the drawing paddles 131, the opening/closing operation of the swing guide 149, and the discharge of the bundle respectively on a basis of results of the discharge HP (home position) detection sensor S342 and others.

The binding control portion 709 includes a clinch motor M280, a stapler moving motor M303, and a stapler home sensor S303. The binding control portion 709 executes controls on the move of the stapler 132 and on the operation of the clinch.

### [Operation of the Scoring Device]

Next, the operation of the scoring process carried out by the scoring device 201 will be explained further with reference to FIGS. 4A through 4D. It is noted that FIGS. 4A through 4D are section views consecutively showing the operations of the scoring device 201.

When the sheet S is sent from the apparatus body 600 to the sheet processing apparatus 100, the sheet processing apparatus 100 carries out the following operations. That is, on a basis of the detection of a position of the sheet by the entrance sensor S101, the sheet processing apparatus control portion 636 stops the entrance roller pair 102 and the shift roller pairs 105 and 106 at a point of time when the sheet S has advanced by a predetermined distance as shown in FIG. 4A. At this time, the pressing member (punch) 230 stands by at its home position in the scoring device 201 (the punch HP sensor S240 is ON).

Next, the drive of the punch slide motor M215 is transmitted to the slide plate 208 through the pinion 213 (FIG. 3A) as shown in FIG. 4B and acts in a thrust direction (in a direction of an arrow I). At this time, the parallel pins (followers) 223a and 223b move in the vertical direction along the profiles of the cam-like guide long holes 208a and 208b, so that the pressing member 230 moves in a direction of an arrow G in FIG. 4B toward the sheet S and abuts against the die 234.

The slider 232 drops further in the direction of the arrow G along the profile of the cam-like guide long hole 208a until when the slider 232 reaches a lower dead point, and the pressing springs 231 presses the die 234 in a direction of an arrow H as shown in FIG. 4C. As a result, a score line is formed on the sheet S.

After that, the pressing member 230 moves in the thrust direction (in the direction of the arrow I in FIG. 4B) through the slide plate 208 and moves to a retract position from the sheet conveying path 207. Then, the entrance roller pair 102 and the shift roller pairs 105 and 106 convey the sheet S downstream.

When a predetermined period of time elapses since when the move of the pressing member 230 to the retract position has been completed, the slide plate 208 starts to move to its home position. Here, FIG. 13 shows a state of the sheet S scored by the scoring device 201.

As shown in FIGS. 13 and 14, the scoring process has been implemented on the cover sheet Sc at four places indicated by H1 through H4. Here, H1 is a score line corresponding to a foldback position on a back side of a back cover B of the cover sheet Sc, H2 is a score line corresponding to a foldback position on the back side of the front cover F, H3 is a score line corresponding to a foldback position on an opening (front edge) side of the front cover F, and H4 is a score line corresponding to a foldback position on the opening side of the back cover B.

That is, as shown in FIG. 14, the score line H3 (first score line) is formed on the cover sheet Sc at a position (distance) separated from the upstream end in the sheet conveying direction by a distance corresponding to a widthwise dimension d₁ of the bookblock (bookblock sheet) Sn in the sheet conveying direction. Further, the score line H2 (second score line) is formed on the cover sheet Sc at a position separated from the score line H3 by a distance corresponding to the widthwise dimension d₁ of the bookblock Sn. Further, the score line H1 (third score line) is formed on the cover sheet Sc at a position separated from the score line H2 by a distance corresponding to a thickness dimension d₂ of the bookblock (bookblock sheet) Sn. Still further, the score line H4 (fourth score line) is formed on the cover sheet Sc at a position separated from the score line H1 by the distance corresponding to the widthwise dimension d₁ of the bookblock Sn.

It is noted that the scoring device 201 can accommodate to the thickness and the length in the conveying direction of the sheet bundle by changing a timing of stopping the entrance roller pair 102 and the shift roller pairs 105 and 105 in accordance to the score lines H1 through H4. That is, the scoring device 201 can change the distance between the score lines scored to cover the side edges of the bookblock (Sn) corresponding to the thickness of the stacked booklet (Sn). This makes it possible to readily obtain the cover sheet Sc corresponding to the bookblocks Sn having various thicknesses.

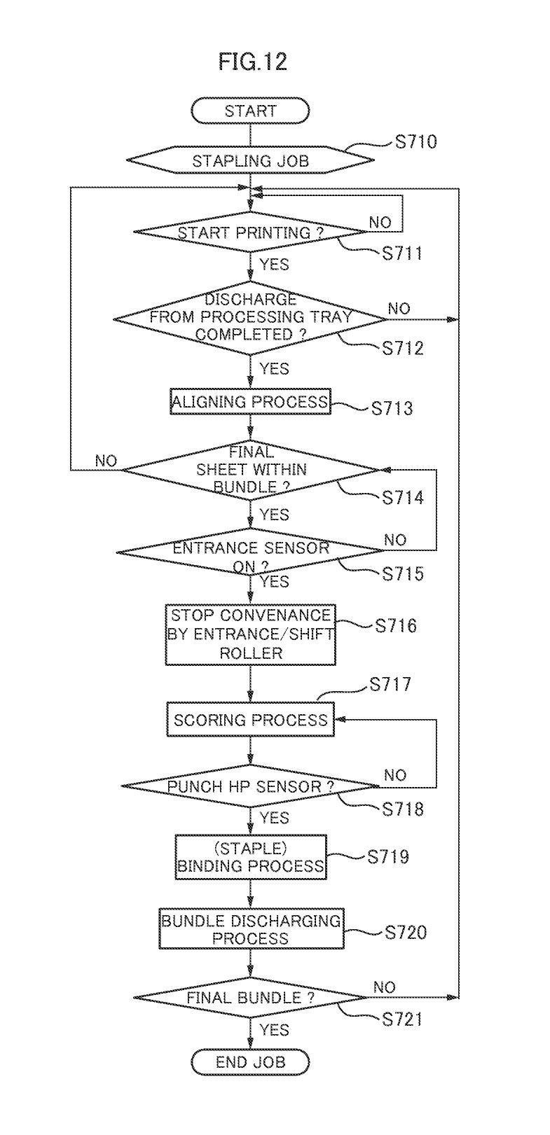

Next, the series of scoring processes described above will be explained by using a flowchart shown in FIG. 12. It is noted that FIG. 12 is a flowchart showing processes to be carried out when the stapling job is selected in the sheet processing apparatus control portion 636 through the manipulation portion 601 of the apparatus body 600.

That is, as shown in FIG. 12, when the user selects the stapling job (Job) through the manipulation portion 601 in Step S710, it is judged whether or not a print is to be started in the apparatus body 600 in Step S711. The judgment of Step S711 is continued (No in S711) until when a print start command is inputted as a result. When the print start command is inputted (Yes in S711), the process advances to Step S712 to judge whether or not the discharge of the sheet to the processing tray 138 is completed.

In Step S712, every time when the discharge of the sheet to the processing tray 138 is completed one by one (Yes in S712), the alignment process by the front and rear aligning plates 340 and 341 is carried out in Step S713.

In Step S714, it is judged whether or not the discharged sheet is a final sheet within a bundle set in advance in the manipulation portion 601. If the discharged sheet is the final sheet within the bundle as a result (Yes in S714), the sheet processing apparatus control portion 636 detects a position of the sheet while judging whether or not the entrance sensor S101 is turned ON. When the entrance sensor S101 turns ON, (Yes in S715), the sheet processing apparatus control portion 636 stops the entrance roller pair 102 and the shift roller pairs 105 and 106 to stop the final sheet at a predetermined position in Step S716.

When the sheet processing apparatus control portion 636 stops the final sheet at the predetermined position, the sheet processing apparatus control portion 636 causes the scoring device 201 to be driven at a predetermined timing to execute the scoring process of scoring a plurality of predetermined score lines on the final sheet in the width direction orthogonal to the sheet conveying direction (S717).

After that, when the pressing member 230 returns to its home position, the punch HP sensor S240 (FIG. 3A) turns ON in Step S718. Based on that, the sheet processing apparatus control portion 636 drives the entrance roller pair 102 and the shift roller pairs 105 and 106 to convey the final sheet to the processing tray 138 of the side stitching portion 700.

When the alignment process of the final sheet on the processing tray 138 is finished, the sheet processing apparatus control portion 636 executes the stapling process by the stapler 132 in Step S719 and then executes the bundle discharge process of discharging the sheet bundle, i.e., a booklet, to the lower discharge tray 137 in Step S720.

Succeedingly, the sheet processing apparatus control portion 636 judges whether or not the bundle is a final bundle within bundles in Step S721. When the bundle is not the final bundle within the bundles (No in Step S721), the sheet processing apparatus control portion 636 repeats the processes from the Step S711 and executes the operation of discharging a next sheet to the processing tray 138. The sheet processing apparatus control portion 636 repeats these operations until the final bundle, and when it is judged in Step S721 that the bundle is the final bundle (Yes in S721), the stapling Job is finished.

FIG. 14 shows a state of a booklet Bo which is a product in which the final sheet Sit (cover sheet Sc) is integrated with the bookblock Sn and which is discharged to the lower discharge tray 137. The score line H1 corresponding to the foldback position on the back side of the front cover F is formed on the final sheet S1t (cover sheet Sc) by the scoring device 201. Still further, the score line H2 corresponding to the foldback position on the back side of the back cover B, the score line H3 corresponding to the foldback position on the opening side of the front cover F, and the score line H4 corresponding to the foldback position on the opening side of the back cover B are formed.

These score lines H1 through H4 are folded back so as to cover the bind portion Sk to which staples st are driven in order of H3, H2 and H1. Thereby, it is possible to bookbind the booklet Bo, i.e., the product having a good appearance. Still further, it is possible to make the front or back cover hard to separate from the bookblock Sn by inserting a part extending from the score line H4 into the open side of the bookblock Sn. This arrangement makes it possible to improve handleability.

That is, the front or back cover may be configured so as to have the part projecting to the open side and to be inserted into the bookblock at an end portion (H4) thereof. The scoring device 201 may be also configured such the positions of the score lines of the front or back cover can be varied corresponding to the thickness of the sheet bundle.

The present embodiment described above makes it possible to obtain the booklet Bo as the good appearance product by folding the cover sheet Sc bound with the bookblock Sn by the stapler 132 by the score lines so as to cover the bind portion Sk. Still further, because the front and back covers of the one cover sheet Sc is bound with the bookblock Sn, the cover sheet Sc is not separated from the bookblock Sn and the handleability of the booklet is improved.

Still further, because the bound part is covered in either cases of binding by staples (stapler needles), glue and tape, no irregularity otherwise caused by adhesive appears on the surface of the sheet bundle. The present embodiment also makes it unnecessary to use an expensive bound part such as glue and tape to improve an appearance, so that a bookbinding cost of the booklet is cut and a bookbinding apparatus can be also downsized and simplified. It is noted that while the upstream ends in the sheet conveying direction of the cover sheet and the bookblock are aligned and bound in the embodiment described above, the downstream ends may be also aligned and bound for example. In this case, the downstream end is the first end and the upstream end is a second end, and the first through fourth score lines are formed on a basis of the downstream end.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-044060, filed on Mar. 6, 2013 which is hereby incorporated by reference herein in its entirety.

What is claimed is:

1. A sheet processing apparatus configured to process a sheet bundle and a cover sheet covering the sheet bundle, the sheet processing apparatus comprising:
a scoring portion configured to score a plurality of score lines at a plurality of positions of the cover sheet, the positions of the score lines scored by the scoring portion corresponding to a plurality of side edges of the sheet bundle in covering the sheet bundle by the cover sheet;
a sheet stacking portion configured to stack the sheet bundle and the cover sheet in a state in which first ends thereof are aligned; and
a binding portion configured to bind the sheet bundle with the cover sheet respectively stacked on the sheet stacking portion by binding the first ends of the sheet bundle and the cover sheet.

2. The sheet processing apparatus according to claim 1, wherein the scoring portion scores the plurality of score lines on the cover sheet at the positions corresponding to the plurality of side edges of the sheet bundle such that the cover sheet whose first end is aligned with the first end of the sheet bundle is folded back at a second end opposed to the first end of the sheet bundle and is turned around to a back of the sheet bundle so as to cover the first end of the sheet bundle.

3. The sheet processing apparatus according to claim 1, wherein the scoring portion varies a distance between at least two score lines among the plurality of score lines scored to cover the first end of the sheet bundle in accordance to a thickness of the sheet bundle stacked on the sheet stacking portion.

4. The sheet processing apparatus according to claim 1, wherein the scoring portion scores, on the cover sheet, a first score line at a position separated from the first end of the cover sheet by a distance corresponding to a widthwise dimension from the first end to a second end opposed to the first end of the sheet bundle, a second score line at a position separated from the first score line by the distance corresponding to the widthwise dimension of the sheet bundle, and a third score line at a position separated from the second score line by a distance corresponding to a dimension of a thickness of the sheet bundle.

5. The sheet processing apparatus according to claim 4, wherein the scoring portion scores a fourth score line on the cover sheet at a position separated from the third score line by the distance corresponding to the widthwise dimension of the sheet bundle.

6. The sheet processing apparatus according to claim 1, wherein the scoring portion includes:
a die having a straight concave portion, and
a pressing member having a straight convex portion extending above the die in parallel with the concave portion of the die and entering the concave portion.

7. A sheet processing apparatus comprising:
a sheet conveying portion configured to convey a plurality of sheets forming a bookblock of a booklet and a cover sheet having a size larger than each sheet of the bookblock and forming a cover of the booklet;
a scoring portion configured to score a plurality of score lines on the cover sheet at a plurality of positions corresponding to a plurality of side edges of the bookblock along a width direction orthogonal to a sheet conveying direction in covering the bookblock by the cover sheet;
a sheet stacking portion configured to stack the bookblock and the cover sheet scored by the scoring portion in a state in which first ends in the sheet conveying direction thereof are aligned; and
a binding portion configured to bind the bookblock with the cover sheet stacked on the sheet stacking portion by binding the first ends in the sheet conveying direction of the bookblock and the cover sheet to form the booklet in which a second end in the sheet conveying direction opposite from the first end of the cover sheet extends out of the bookblock.

8. The sheet processing apparatus according to claim 7, wherein the scoring portion scores the plurality of score lines on the cover sheet at the positions corresponding to the plurality of side edges of the bookblock such that the cover sheet whose first end in the sheet conveying direction is aligned with the first end of the sheet bundle is folded back at the second end in the sheet conveying direction of the bookblock and is turned around to a back of the bookblock by covering the first end in the sheet conveying direction of the bookblock.

9. The sheet processing apparatus according to claim 7, wherein the scoring portion varies a distance between at least two score lines among the plurality of score lines scored to cover the first end of the bookblock in accordance to a thickness of the sheet bundle stacked on the sheet stacking portion.

10. The sheet processing apparatus according to claim 8, wherein the scoring portion varies a distance between at least two score lines among the plurality of score lines scored to cover the first end of the bookblock in accordance to a thickness of the sheet bundle stacked on the sheet stacking portion.

11. The sheet processing apparatus according to claim 7, wherein the scoring portion forms, on the cover sheet, a first score line at a position separated in the sheet conveying direction from the first end by a distance corresponding to a widthwise dimension of the bookblock, a second score line at a position separated from the first score line by the distance corresponding to the widthwise dimension of the bookblock, and a third score line at a position separated from the second score line by a distance corresponding to a dimension of a thickness of the bookblock.

12. The sheet processing apparatus according to claim 10, wherein the scoring portion forms, on the cover sheet, a first score line at a position separated in the sheet conveying direction from the first end by a distance corresponding to a widthwise dimension of the bookblock, a second score line at a position separated from the first score line by the distance corresponding to the widthwise dimension of the bookblock, and a third score line at a position separated from the second score line by a distance corresponding to a dimension of a thickness of the bookblock.

13. The sheet processing apparatus according to claim 11, wherein the scoring portion scores a fourth score line on the cover sheet at a position separated from the third score line by the distance corresponding to the widthwise dimension of the bookblock.

14. The sheet processing apparatus according to claim 12, wherein the scoring portion forms a fourth score line on the cover sheet at a position separated from the third score line by the distance corresponding to the widthwise dimension of the bookblock.

15. The sheet processing apparatus according to claim 7, wherein the scoring portion includes:
a die extending in a width direction orthogonal to the sheet conveying direction and having a straight concave portion; and
a pressing member having a straight convex pressing portion extending above and in parallel with the die and entering the concave portion, the pressing member being supported to be contactable/separable to/from the die.

16. The sheet processing apparatus according to claim 14, wherein the scoring portion includes:
a die extending in a width direction orthogonal to the sheet conveying direction and having a straight concave portion; and
a pressing member having a straight convex pressing portion extending above and in parallel with the die and entering the concave portion, the pressing member being supported to be contactable/separable to/from the die.

17. A booklet bookbinding method comprising steps of:
conveying a plurality of sheets forming a bookblock of a booklet and a cover sheet having a size larger than each sheet of the bookblock and forming a cover of the booklet;
scoring a plurality of score lines on the cover sheet at a plurality of positions corresponding to a plurality of side edges of the bookblock along a width direction orthogonal to a sheet conveying direction in covering the bookblock by the cover sheet;
stacking the bookblock and the cover sheet scored by the scoring portion in a state in which first ends in the sheet conveying direction thereof are aligned; and
binding the bookblock with the cover sheet stacked in the sheet stacking step by binding the first ends in the sheet conveying direction of the bookblock and the cover sheet to form a booklet in which a second end in the sheet conveying direction opposite from the first end of the cover sheet extends out of the bookblock.

18. The booklet bookbinding method according to claim 17, wherein the plurality of score lines is formed on the cover sheet in the scoring step as a first score line at a position separated in the sheet conveying direction from the first end by a distance corresponding to a widthwise dimension of the bookblock in the sheet conveying direction, a second score line at a position separated from the first score line by the distance corresponding to the widthwise dimension of the bookblock, and a third score line at a position separated from the second score line by a distance corresponding to a dimension of a thickness of the bookblock.

19. A booklet comprising a plurality of sheets forming a bookblock and a cover sheet having a size larger than each sheet of the bookblock and forming a cover of the booklet, the bookblock being bound with the cover sheet by binding first ends of the bookblock and the cover sheet,
the cover sheet having a plurality of score lines scored at positions corresponding to a plurality of side edges of the bookblock such that the cover sheet whose first end is aligned with the first end of the bookblock is folded back at a second end opposite from the first end and is turned around to a back of the bookblock so as to cover the first end of the bookblock.

20. The booklet according to claim 19, wherein the cover sheet has a first score line formed at a position separated from one end thereof by a distance corresponding to a widthwise dimension of the bookblock, a second score line formed at a position separated from the first score line by the distance corresponding to the widthwise dimension of the bookblock, and a third score line formed at a position separated from the second score line by a distance corresponding to a dimension of a thickness of the bookblock.
